(19) United States
(12) Patent Application Publication
(10) Pub. No.: US 2023/0252311 A1
(43) Pub. Date: Aug. 10, 2023

(54) SYSTEMS AND METHODS FOR TRANSDUCTIVE OUT-OF-DOMAIN LEARNING

(71) Applicant: Clarifai, Inc., Wilmington, DE (US)

(72) Inventors: Eran Nussinovitch, New York, NY (US); Trey Pierce, Brooklyn, NY (US)

(21) Appl. No.: 17/668,650

(22) Filed: Feb. 10, 2022

(51) Int. Cl. G06N 5/02; G06N 5/04

(52) U.S. Cl. CPC G06N 5/022; G06N 5/04

(57) ABSTRACT

Systems, methods and computer program code are provided to classify an input using a base model. In some embodiments, the input is from a different domain than a set of inputs used to train the base model.

### BACKGROUND

The fields of artificial intelligence and machine learning are advancing rapidly, with dramatic improvements in accuracy and efficiency. Despite these advances, it remains difficult to perform certain tasks accurately and with computational efficiency. For example, it remains difficult to perform image classification tasks using models trained on different domains (sometimes referred to as “out-of-domain image distribution”). It is even more difficult to perform such image classification with zero or few-shot learning approaches. The ability to recognize and/or distinguish an object from a small amount of samples is tremendously difficult. Current zero to few-shot techniques replace the last fully connected layers when applying transfer learning and therefore lose some contextual knowledge and part of the relations field that exists between the objects and is captured in those layers in the hope that they could be reestablished via either shallow or deep training.

It would be desirable to provide systems and methods for transductive out-of-domain learning It would further be desirable to provide systems and methods which allow the classification of items of a different modality and which uses less computation and adds explainability when compared to existing methods.

### SUMMARY

According to some embodiments, systems, methods and computer program code are provided to classify inputs are provided. Pursuant to some embodiments, inputs from one domain may be classified using a model trained using inputs from a different domain. In some embodiments, systems, methods and computer program code are provided to classify an input by applying a base model to the input. The base model generates a prediction of one or more first base concepts associated with the input. A determination is made that at least a first custom concept exists which is mapped to the first base concept and the at least first custom concept is output as a classification of the input. Pursuant to some embodiments, the input may from a different domain than a set of inputs used to train the base model. For example, the input may be from a real-world image while the base model may have been trained on catalog images as will be described further below.

A technical effect of some embodiments of the invention is an improved, cost effective and efficient out of domain learning approach to be applied using a base model. Embodiments are explainable at least because the use of an ignore list and voting method allows the identification of the contribution of each base concept. Embodiments are architecture-independent, and the approach requires no backpropagation and is usable on limited knowledge. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system pursuant to some embodiments.

FIG. 2 illustrates a process pursuant to some embodiments.

FIG. 3 illustrates a process pursuant to some embodiments.

FIG. 4 illustrates a portion of a user interface that may be used pursuant to some embodiments.

FIG. 5 illustrates a portion of user interface that may be used pursuant to some embodiments.

FIG. 6 is block diagram of a classification platform pursuant to some embodiments.

### DETAILED DESCRIPTION

Enterprises, businesses and other users frequently wish to use artificial intelligence (“AI”) or machine learning models (generally referred to herein as “models”) to identify or classify features or items in images or videos. Often, the models that are used are trained using images from one domain. It is difficult to then use those models for the classification of images from another domain. As a particular example that will be used to illustrate features of the present invention in the following disclosure, many models are trained on catalog images, or images of items (such as products) that are placed on a white background. These catalog-style images frequently stage or position the product in the center of a white background. Classification models trained on such catalog-style images can be trained to be highly accurate in classifying images of the same style (where the product or item in the image is centered on a white background). However, such models may not be as accurate in classifying images from a different domain (e.g., such as real-world images of products in use or in other environments).

Applicants have recognized that it would be desirable to provide systems and methods to allow the classification of items of a different domain or modality which uses less computational power and adds explainability as compared to other approaches. As used here, the term “automated” or “automatic” may refer to, for example, actions that can be performed with little or no human intervention.

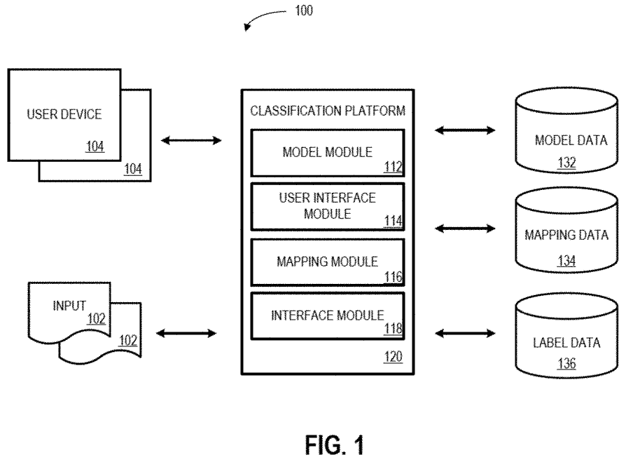

Features of some embodiments will now be described by first referring to FIG. 1 which is a block diagram of a system 100 according to some embodiments of the present invention. As shown, system 100 includes a classification platform 120 which receives inputs 102 (such as images, videos or the like) and which produces outputs (stored as output data 136) such as meta data, attributes or the like that results from processing an input 102 using features of the present invention. For example, the output data 136 may include data associated with the classification of an input 102 even where the input 102 is from a different domain or type of input a model was trained on (e.g., such as where the input 102 is an image in a real-world setting and the model is one trained on catalogue-like images).

In some embodiments, the system 100 allows one or more users operating user devices 104 to interact with the classification platform 120 to perform classification processing of those inputs 102 as described further herein. The classification platform 120 includes one or more modules that are configured to perform processing to classify inputs 102 as described further herein. Pursuant to some embodiments, the classification platform 120 includes (or is in communication with) a base model 112. For example, the base model 112 may be a classification model that has been trained and configured to take an input (such as an image or video), run a prediction, and output one or more “concepts” predicted by the model. A concept represents a word that the model predicts is associated with the input. A concept can be a concrete notion such as “dog” or “cat” or an abstract notion such as “love”. Pursuant to some embodiments, the application of a base model to an input 102 results in the output of a set of concepts as output data associated with the input. In some embodiments, each concept may have a unique identifier, a name (such as a label or a tag) and a confidence score which represents a level of confidence the model has in the predicted concept.

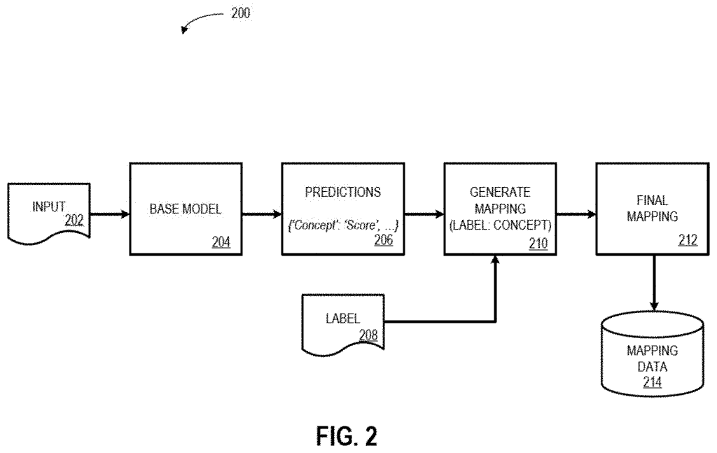

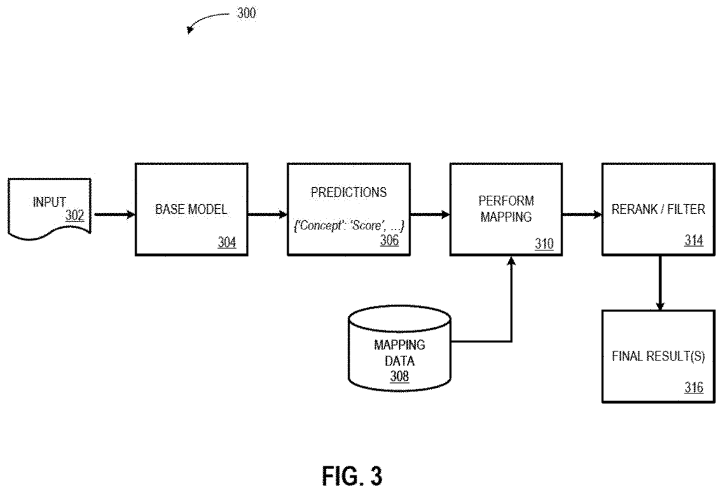

The classification platform 120 may include a mapping module 116 associated with mapping data 134. The mapping module 116 may be operated to create a number of associations between concepts predicted using a base model and a number of custom concepts associated with inputs in a different domain. The application and use of the mapping module 116 in the classification of out-of-domain inputs will be described further below in conjunction with a description of the processes of FIGS. 2 and 3.

Pursuant to some embodiments, the system 100 includes components and interfaces that allow the creation of mapping data 134 that may be used to perform classification processing of inputs from different domains. Embodiments of the present invention provide out-of-domain processing that is performed with desirable accuracy and efficiency and in a manner that provides explainable results. The system 100 may generally be referred to herein as being (or as a part of) a “machine learning system”. The system 100 can include one or more models that may be stored at, for example, a model database 132 and interacted with via a component or controller such as model module 112. In some embodiments, one or more of the models may be so-called “classification” models that are configured to receive and process inputs 102 and generate output data 136. As used herein, the term “classification model” can include various machine learning models, including but not limited to a “detection model” or a “regression model.” Embodiments may be used with other models, and the use of a classification model as the illustrative example is intended to be illustrative but not limiting. As a result, the term “model” as used herein, is used to refer to any of a number of different types of models (from classification models to segmentation models or the like).

For clarity and ease of exposition, the term “concept” is used herein to refer to a predicted output of a model. For example, in the context of a classification model, a “concept” may be a predicted classification of an input. Embodiments are not limited to use with models that produce “concepts” as outputs—instead, embodiments may be used with desirable results with other model output types that are stored or written to a memory for further processing. For convenience and ease of exposition, to illustrate features of some embodiments, the term “confidence score” is used to refer to an indication of a model's confidence of the accuracy of an output (such as a “concept” output from a model such as a classification model). The “confidence score” may be any indicator of a confidence or accuracy of an output from a model, and a “confidence score” is used herein as an example. In some embodiments, the confidence score is used as an input to one or more threshold models to determine further processing actions as will be described further herein.

According to some embodiments, an “automated” classification platform 120 may use mapping data 134 to automatically classify inputs 102 that are in a different domain as described further herein.

In some embodiments, a user device 104 may interact with the classification platform 120 via a user interface (e.g., via a web browser) where the user interface is generated by the classification platform 120 and more particularly by the user interface module 114. In some embodiments, the user device 104 may be configured with an application (not shown) which allows a user to interact with the classification platform 120. In some embodiments, a user device 104 may interact with the classification platform 120 via an application programming interface (“API”) and more particularly via the interface module 118. For example, the classification platform 120 (or other systems associated with the classification platform 120) may provide one or more APIs for the submission of inputs 102 for processing by the classification platform 120.

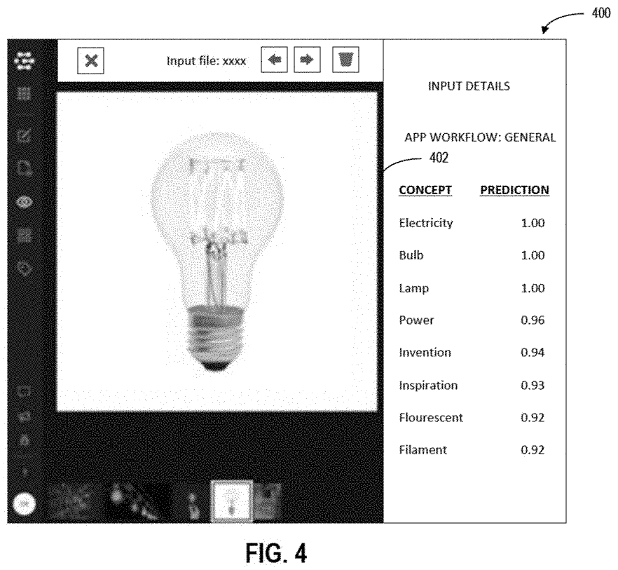

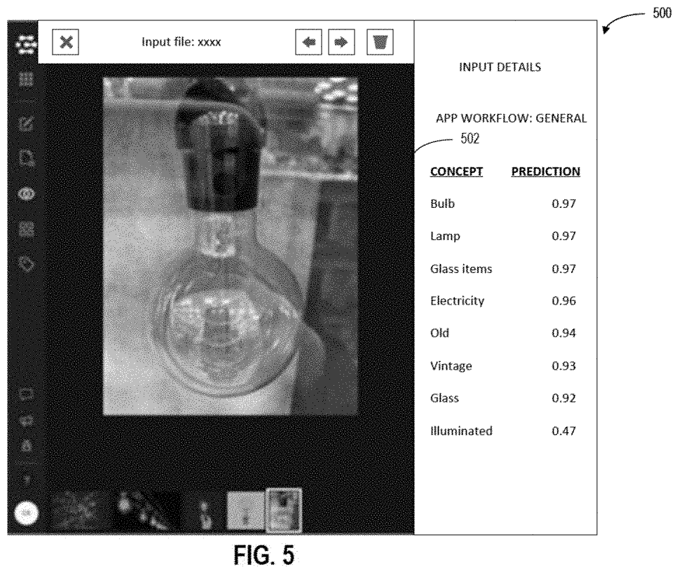

For the purpose of illustrating features of some embodiments, the use of a web browser interface will be described; however, those skilled in the art, upon reading the present disclosure, will appreciate that similar interactions may be achieved using an API. Illustrative (but not limiting) examples of portions of web browser interfaces pursuant to some embodiments will be described further below in conjunction with FIGS. 4 and 5.

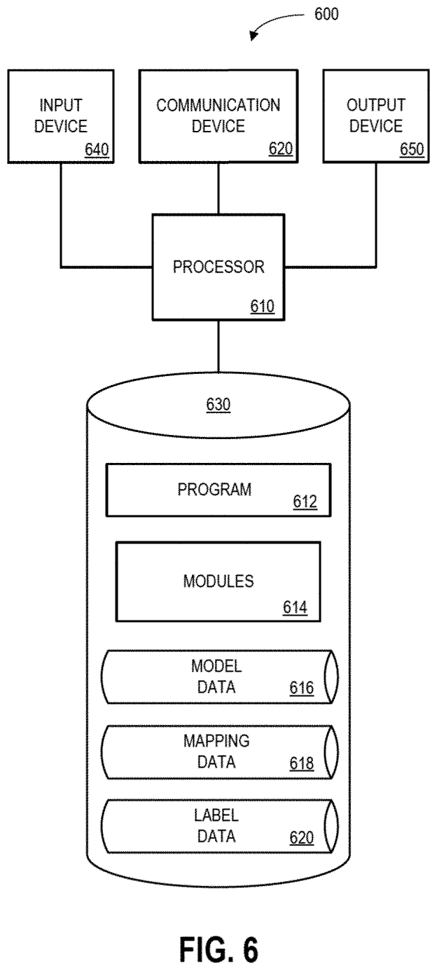

The system 100 can include various types of computing devices. For example, the user device(s) 104 can be mobile devices (such as smart phones), tablet computers, laptop computer, desktop computer, or any other type of computing device that allows a user to interact with the classification platform 120 as described herein. The classification platform 120 can include one or more computing devices including those explained below with reference to FIG. 6. In some embodiments, the classification platform 120 includes a number of server devices and/or applications running on one or more server devices. For example, the classification platform 120 may include an application server, a communication server, a web-hosting server, or the like.

The devices of system 100 (including, for example, the user devices 104, inputs 102, classification platform 120 and databases 132, 134 and 136) may communicate using any communication platforms and technologies suitable for transporting data and/or communication signals, including any known communication technologies, devices, media, and protocols supportive of data communications. For example, the devices of system 100 may exchange information via any wired or wireless communication network such as the Internet, an intranet, or an extranet. Note that any devices described herein may communicate via one or more such communication networks.

Although a single classification platform 120 is shown in FIG. 1, any number of such devices may be included. Moreover, various devices described herein might be combined according to embodiments of the present invention. For example, in some embodiments, the classification platform 120 and databases 132, 134 and 136 might be co-located and/or may comprise a single apparatus.

The system 100 may be operated to facilitate out-of-domain classification of inputs in a way which relates real world concepts to concepts predicted by a machine learning model (and which also identifies each concept's contribution to the relationship). The system and methods of the present invention are highly scalable, architecture free, and do not require backpropagation (unlike other cross-domain approaches such as transfer learning, zero/few shot learning or ensemble learning). As compared to current transfer learning techniques (which do require backpropagation), embodiments require over two times less memory for process, provide over ten times faster training, one and a half times faster inferencing and a one third greater performance overall.

Features of some embodiments will be described by first describing a preprocessing or training process 200 (in conjunction with FIG. 2) and then an inferencing (or classification) process 300 (in conjunction with FIG. 3). Prior to those descriptions, a brief illustrative (but not limiting) example will first be introduced. In the illustrative example, an organization uses the system 100 of the present invention to classify images using a base model that has been trained using images primarily from a first domain (such as, for example, a catalog domain). The images to be classified are from another domain, such as, for example, a real-world image domain. Pursuant to some embodiments, the organization first operates the system 100 to perform a preprocessing or training process that creates a mapping or association between the concepts from the base model to a set of custom concepts. The organization may then operate the system 100 to perform inferencing on inputs. The system 100 maps concepts output from the base model to the custom concepts associated with the real-world images and outputs those custom concepts as the final results.

The final results may be output after a ranking and distribution process is applied to cause a set of final concepts to be presented in association with each input image. As a specific illustrative but not limiting example, the input image is an image such as the image 502 shown in FIG. 5 which includes a light bulb in the foreground and a tabletop in the background behind the light bulb. That is, the image 502 is from a “real-world” domain. The model may have been trained using catalog-style images such as the illustrative image 402 shown in FIG. 4 (where a light bulb is shown on a white background). These images may be referred to as being from a “catalog domain”. Embodiments allow such a model to be enhanced with a mapping of concepts from the model to a set of custom concepts. This allows images from a real-world (or other) domain to be classified using a model that was trained on images from a different domain (such as a catalog domain).

Reference is now made to FIG. 2 where a preprocessing or training process 200 is shown that might be performed by some or all of the elements of the system 100 described with respect to FIG. 1 according to some embodiments of the present invention. The flow charts and process diagrams described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The training process 200 of FIG. 2 may be performed via a user interface (e.g., by a user interacting with a user interface of a user device 104), via an API associated with the classification platform 120 or, in some embodiments, as an automated or partially-automated process. For simplicity and ease of exposition, the process 200 will be described as being configured via a user interface (although those skilled in the art will appreciate that each step may be performed via an API or the like).

Process 200 begins at 202 where an input is received. For example, in the illustrative example introduced above, an image 402 of a light bulb may be received at 202. The image may be a catalog-style image of a light bulb (such as the image 402 shown in FIG. 4). Processing continues at 204 where the input is provided to a model (such as, for example, a base or generic model trained to classify a wide variety of inputs). The model operates on the input and produces (at 206) one or more predictions of concepts shown in the input. For example, in the illustrative example, where an image such as the image 402 from FIG. 4 is input at 202, the model may generate a set of predictions such as {light: 0.9, lamp: 0.6, electricity: 0.5, illuminate: 0.7, glass: 0.5, inspiration: 0.8 . . . } (where each predicted concept has an associated confidence score ranging from 0 to 1).

Process 200 continues at 208 where one or more labels are provided to be mapped to the predicted concepts. For example, the label “light bulb” may be provided at 208 as a custom concept. At 210, the concepts predicted by the base model are mapped to the custom concepts provided at 208. The mapping between the concepts and the custom concepts may be two way mappings (for example, the custom concept of “light bulb” may be mapped to the concepts of “light” and “lamp” and “inspiration” and vice versa). Process 200 continues at 212 where a final mapping is created.

Creation of the final mapping at 212 may include filtering the custom concepts mapped to a base concept to keep only those custom concepts that have a confidence score greater than a threshold amount (e.g., such as a threshold to accept the top 50% of custom concepts). The remaining custom concepts (i.e., those that pass the filtering) may be correlated to a new confidence score in a range from 0 to 1. Processing may further include, for each custom concept, summing their prediction counts and their confidence scores to produce a mapping between the custom concepts and the base concept.

In some embodiments, creation of the final mapping at 212 may further include aggregating the results and creating an ignore list by filtering the results and creating a voting scheme. For example, in some embodiments, if the base concept is associated with a relatively large list of custom concepts (or a number of custom concepts over a desired amount), a voting scheme may be run to create an ignore list for the custom concepts mapped to that base concept (thereby reducing the number of custom concepts mapped to the base concept. The final mapping produced at 212 is then stored at 214 for use in an inferencing process such as the process shown in FIG. 3. This process 200 may be repeated for a number of inputs 202 and a number of labels to create a rich set of mapping data 214.

Use of the mapping data will now be described by reference to FIG. 3 which is an inferencing process 300 that may be performed by the system 100 pursuant to some embodiments. For example, the process 300 may be performed after a set of mapping data has been created for a particular application or use case (e.g., such as the illustrative, but not limiting, application described above where classification of images in a real-world domain is to be performed using a base model trained on images from a catalog domain).

The inferencing process 300 of FIG. 3 may be performed via a user interface (e.g., by a user interacting with a user interface of a user device 104), via an API associated with the classification platform 120 or, in some embodiments, as an automated or partially-automated process. For simplicity and ease of exposition, the process 300 will be described as being configured via a user interface (although those skilled in the art will appreciate that each step may be performed via an API or the like).

The inferencing process 300 begins at 302 where an input is received. For example, continuing the illustrative example introduced above, the input may be a real-world image such as the image 502 of a light bulb. For the purpose of illustrating features of the present invention, it may be assumed that the input received at 302 is an input (such as an image, video or the like) that is from a different domain than inputs that were used to train a base model. Processing continues at 304 where a base model is operated 304 to operate on the input and produce (at 306) one or more predictions of concepts shown in the input. For example, in the illustrative example, where an image such as the image 502 from FIG. 5 is input at 302, the model may generate a set of predictions such as {light: 0.8, lamp:0.3, electricity: 0.6, illuminate: 0.4, glass: 0.9, inspiration: 0.4}.(where each predicted concept has an associated confidence score ranging from 0 to 1). This set of predictions may generally be referred to herein as predictions of the “base concepts” (e.g., the concepts predicted by operation of the base model at 304).

Processing continues at 310 where a mapping process is performed to map from the base concepts to the custom concepts using the mapping data stored at 308 (e.g., the mapping data created by operation of the process 200 of FIG. 2). Continuing the illustrative example, process 200 of FIG. 2 may have resulted in the creation of mapping data indicating a relationship between the base concept of “light” with the custom concepts of “light bulb” and “lamp”. Further, the mapping data may indicate a relationship between the base concept of “inspiration” and the custom concepts of “light bulb” and “bookshelf” as well as the base concept of “no person” with the custom concepts of “light bulb”, “lamp” and “bookshelf”. In some embodiments, each of the concepts predicted by the base model at 306 are mapped to any corresponding custom concepts at 310. The resulting set of custom concepts may then be processed by reranking and filtering (at 314) to produce a final result set at 316.

Pursuant to some embodiments, reranking and filtering at 314 may include identifying an ignore list associated with the base concept(s) and applying that ignore list to remove any predictions that are on the ignore list. The remaining set of custom concepts may then be reranked based on their confidence scores to produce a set of custom concepts with associated confidence scores. In this manner, embodiments provide a cost effective and efficient out of domain learning approach to be applied using a base model. Embodiments are explainable at least because the use of an ignore list and voting method allows the identification of the contribution of each base concept. Embodiments are architecture-independent, and the approach requires no backpropagation and is usable on limited knowledge.

The embodiments described herein may be implemented using any number of different hardware configurations. For example, FIG. 6 illustrates a classification platform 600 that may be, for example, associated with the system 100 of FIG. 1 as well as the other systems and components described herein. The classification platform 600 comprises a processor 610, such as one or more commercially available central processing units (CPUs) in the form of microprocessors, coupled to a communication device 620 configured to communicate via a communication network (not shown in FIG. 6). The communication device 620 may be used to communicate, for example, with one or more input sources and/or user devices. The classification platform 600 further includes an input device 640 (e.g., a mouse and/or keyboard to define rules and relationships) and an output device 650 (e.g., a computer monitor to display reports and results to an administrator).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or one or more software modules 614 (e.g., associated with the user interface module, model module and mapping module of FIG. 1) for controlling the processor 610. The processor 610 performs instructions of the programs 612, 614, and thereby operates in accordance with any of the embodiments described herein. For example, the processor 610 may receive input data and then perform processing on the input data such as described in conjunction with the process of FIGS. 2 and 3. The programs 612, 614 may access, update and otherwise interact with data such as model data 616, mapping data 618 and label data 620 as described herein. In some embodiments, one or more ignore lists may also be stored at or accessible by the system (e.g., defining concepts to be ignored in different mapping relationships).

The programs 612, 614 may be stored in a compressed, uncompiled and/or encrypted format. The programs 612, 614 may furthermore include other program elements, such as an operating system, a database management system, and/or device drivers used by the processor 610 to interface with peripheral devices.

As used herein, information may be “received” by or “transmitted” to, for example: (i) the classification platform 600 from another device; or (ii) a software application or module within the classification platform 600 from another software application, module, or any other source.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A computer implemented method to classify an input, the method comprising:
applying a base model to the input;
predicting at least a first base concept associated with the input;
determining that at least a first custom concept exists which is mapped to the at least first base concept; and
outputting the at least first custom concept as a classification of the input.

2. The computer implemented method of claim 1, wherein predicting at least a first base concept associated with the input further comprises generating a confidence score associated with the at least first base concept.

3. The computer implemented method of claim 1, wherein predicting at least a first base concept associated with the input further comprises:
generating a first confidence score associated with the at least first base concept;
predicting at least a second base concept associated with the input; and
generating a second confidence score associated with the at least second base concept.

4. The computer implemented method of claim 3, further comprising:
determining that at least a second custom concept exists which is mapped to the at least second base concept.

5. The computer implemented method of claim 4, wherein the outputting further comprises:
outputting the at least second custom concept as a classification of the input.

6. The computer implemented method of claim 5, further comprising:
reranking the at least first and second custom concepts to output the highest ranked concept first.

7. The computer implemented method of claim 1, wherein determining that at least a first custom concept exists which is mapped to the at least first base concept further comprises:
querying a mapping data structure using the at least first base concept; and
receiving the at least first custom concept.

8. The computer implemented method of claim 8, wherein the mapping data structure includes a plurality of base concepts including the at least first base concept.

9. The computer implemented method of claim 9, wherein the mapping data structure includes, for each of the plurality of base concepts, information identifying one or more corresponding custom concepts.

10. The computer implemented method of claim 9 wherein the mapping data structure further includes, for the one or more corresponding custom concepts, a confidence score indicating a confidence in the relationship between the one or more corresponding custom concepts and the associated base concept.

11. The computer implemented method of claim 4, further comprising:
comparing the at least first and the at least second custom concepts to an ignore list to determine if either of the at least first and the at least second custom concepts are to be ignored.

12. A system comprising:
a processing unit; and
a memory storage device including program code that when executed by the processing unit causes to the system to:
apply a base model to an input;
predicting at least a first base concept associated with the input;
determining that at least a first custom concept exists which is mapped to the at least first base concept; and
outputting the at least first custom concept as a classification of the input.

13. The system of claim 12, wherein the input is one of an image and a video.

14. The system of claim 12, wherein predicting at least a first base concept associated with the input further comprises program code to:
generate a first confidence score associated with the at least first base concept;
predict at least a second base concept associated with the input; and
generate a second confidence score associated with the at least second base concept.

15. The system of claim 14, further comprising program code that when executed by the processing unit causes to the system to:
determine that at least a second custom concept exists which is mapped to the at least second base concept.

16. The system of claim 15, further comprising program code that when executed by the processing unit causes to the system to:
output the at least second custom concept as a classification of the input.

17. The system of claim 16, further comprising program code that when executed by the processing unit causes to the system to:
rerank the at least first and second custom concepts to output the highest ranked concept first.

18. The system of claim 1, wherein the program code to determine that at least a first custom concept exists which is mapped to the at least first base concept further comprises program code to:
query a mapping data structure using the at least first base concept; and
receive the at least first custom concept.

19. The system of claim 18, wherein the input is from a different domain than a set of inputs used to train the base model.
